(19) United States
(12) Patent Application Publication
(10) Pub. No.: US 2007/0077965 A1
(43) Pub. Date: Apr. 5, 2007

(54) Portable docking station for cell phone

(76) Inventor: Patrick Fox, Pennellville, NY (US)

Correspondence Address: Bernhard P. Molldrem, Jr., 224 Harrison Street, Syracuse, NY, 13202, US

(21) Appl. No.: 11/243,579

(22) Filed: Oct. 5, 2005

(51) Int. Cl. H04B 1/38

(52) U.S. Cl. 455/557

(57) ABSTRACT

A docking station for a music-enabled cell phone has a cradle for holding the cell phone and a cable connector with stereo headset plug at one end and a pair of audio connectors, e.g., RCA connectors, at the other end. The cable may be incorporated into the cradle. The receptacle may also include a connector for recharging or for digital access to the music files stored in the phone. The selection and play of the music can be controlled directly from the cell phone. The docking station can be part of a portable stereo entertainment system.

### BACKGROUND OF THE INVENTION

This invention relates to docking stations for cell phones, i.e., portable hand-held telephones, that are enabled to receive music files and play them over the stereo headsets. The invention is more specifically concerned with provisions for employing the cell phone as a music source for a personal entertainment center or similar amplified stereo audio system.

Recently, cell phones have been introduced that can access, download, store and play music files, i.e., mp3 files. The music files, i.e., songs or tunes, can be selected and downloaded over the wireless phone system, or can be obtained via Internet or from other sources, and are stored on a memory chip on the cell phone. These can be played back for the user as left and right audio signals that are supplied to earphones. The cell phone is provided with a stereo headphone output jack, usually on the upper left side of the cell phone, but sometimes on the back..

This type of cell phone can be used in a manner similar to an MP3 player, e.g., ipod, in addition to its use as a portable wireless phone.

At the present time, there is no means provided for using the cellular phone as a source of music for a stereo audio system, such as a home theater, home stereo, automotive audio system, or portable stereo system (i.e., “boom box”).

### OBJECTS AND SUMMARY OF THE INVENTION

Accordingly, it is an object of this invention to provide a portable cell phone cradle that is adapted to these MP3 type cell phones, and which represents an advance over the prior art.

It is a more specific object to provide a portable docking station that permits the cell phone to be used as a source of audio music for a stereo amplifier or for amplified speakers..

It is another object to provide a cell phone docking station that takes the L and R audio signals from the headset jack and feed same to the left and right channels of an amplifier.

According to one aspect of this invention, a cable connector has a stereo headset plug at one end and a pair of audio connectors, e.g., RCA connectors, at the other end, permitting the cell phone to be connected to inputs of a stereo amplifier. This may be incorporated into a receptacle or cradle that holds the phone, and may include a connector for recharging the battery of the cell phone as well as digital access to the music files stored in the phone. A portable or mobile stereo system has a rechargeable battery to power the system, and an audio amplifier that feeds a pair of speakers. The device may have an external volume control to regulate gain of the amplifier. The selection and play of the music can be controlled directly from the cell phone.

In a preferred mode, the cable has a 90-degree mini phone plug and a pair of RCA output connectors. The cable can be used with any of a number of different models of music-enabled cell phones, and with any of a vast number of audio systems.

Basically, the portable docking station of this invention can accommodate a cell phone instrument of the type capable of downloading and storing music files and playing said files back as stereo audio signals via a stereo headphone jack on the cell phone instrument. A cradle holds the cell phone instrument; and a cable has a stereo plug at one end adapted to fit the stereo jack on the cell phone, and a pair of audio connectors at another end of the cable for connecting to L and R audio inputs of a stereo amplifier. This cable may be contained within the cradle. The audio connectors can mounted on a rear panel of the cradle so that the cradle can be connected directly onto the amplifier. In a preferred mode, the stereo plug is mounted on a slider mechanism contained in the cradle. The slider mechanism provides freedom of motion of the stereo plug over a limited distance, so that the plug can be moved to adjust the cradle for any of a variety of cell phone instruments.

In any of several possible embodiments, the cradle of this invention is incorporated into an audio entertainment system that includes a case, a stereo amplifier within the case, a volume control for controlling gain of the amplifier, and a pair of speakers supplied by said stereo amplifier. The cradle is affixed onto the case, with the audio connectors of said cable being connected to respective inputs of the stereo amplifier; such that the cell phone instrument becomes audio input source for said audio entertainment system. There may also be a connector in the base of the cradle that fits into a digital coupling at a base of said cell phone instrument, and connects to a digital processor within said case for accessing music files as digital files from said cell phone instrument. These can be converted into analog audio files and supplied to the audio amplifier.

The anytime-downloading capability of the music cell phone allow the user to download and play new music as soon as it becomes available, and makes the music cell phone a superior source of music for the stereo system.

The above and many other objects, features, and advantages of this invention will become apparent to persons skilled in the art from the ensuing description of a preferred embodiment, which is to be read in conjunction with the accompanying Drawing.

### BRIEF DESCRIPTION OF THE DRAWING

FIG. 1 is a front view of a portable stereo system, with music cell phone and a holder or cradle on the case of the system, according to one embodiment of the invention.

FIG. 2 shows one version of the stereo cable of this invention.

FIG. 3 is a schematic of a stereo entertainment system according to an embodiment of this invention.

FIG. 4 is a front view of a cradle of an embodiment of the invention.

FIG. 5 is a rear view of a cradle of an embodiment of the invention.

FIG. 6 is a perspective showing one possible layout of a system of this invention.

### DETAILED DESCRIPTION OF THE PREFERRED EMBODIMENT

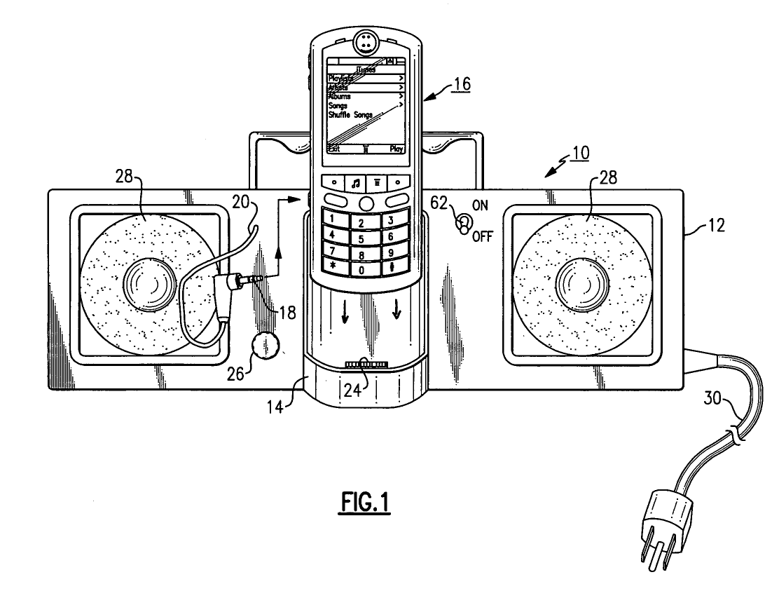

With reference to the Drawing, and initially to FIG. 1, a portable stereo system 10 has a case or housing 12, with a cell phone cradle 14 positioned at the center of the front panel, and which is adapted for holding a cellular portable wireless phone 16. The cell phone 16 is a music-enabled phone, which has a provision for downloading and storing music files, i.e., MP3 digital files, which can be selected and played over a set of earphones that plug into a stereo socket or jack on the side or back of the cell phone. In this embodiment, a cord or cable 20 extends from the front of the case 12 and has a mini-phone plug 18 that can be plugged into the socket at the side or back of the cell phone 16. This permits the cell phone 16 to be used as a source for music to be amplified and played by the portable stereo system. The cell phone has a display showing the various stored music selections and these are selected for playing using various ones of the keys on the cell phone.

Also shown here within the cradle 14 is a connector 22 with a number of electrical contacts that mate with electrical contacts at the base or foot of the cell phone 16. This connector has contacts providing power for recharging the cell phone battery, and can also have contacts for connecting with the digital equipment within the cell phone to permit downloading of the digital files to a memory within the portable stereo system 10. A master volume control knob 26 which serves as amplifier gain control is positioned on the front of the housing, and there are also left and right channel loudspeakers 28, 28. A removable power cord 30 is provided for plugging the system 10 into a convenient AC power source, or alternatively into a 12 volt source in an automotive electrical system.

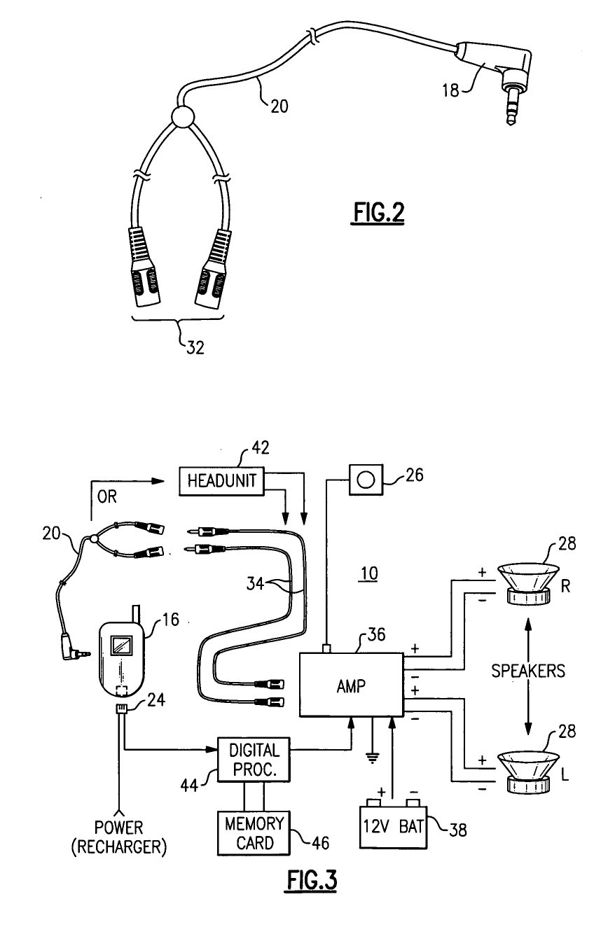

FIG. 2 illustrates the basic design of the cable 20 for connecting the phone 16 to the stereo audio system. Here the cable 20 has a right-angle stereo mini-plug 18 at one end and a pair of RCA-type connectors 32, 32 at the other end to provide left and right audio signals to mating connectors on an audio amplifier.

FIG. 3 shows schematically the connection of the music enabled phone 16 to the stereo system 10. A pair of audio cables 34 connect the cable 20 to inputs of left and right channels of an audio amplifier 36. The latter amplifies the signal, where the gain is controlled by the master volume control or gain control 26, and then supplies the amplified L and R audio signals to the speakers 28, 28. The system can include a battery 38, here 12 volts DC, as a power source. An alternative audio head unit 42 can be used in stead of the cables 34 to supply an audio signal to the amplifier 36.

As also shown here the connector 22 provides power for recharging the cell phone battery, and also provides a path for downloading MP3 music files from the cell phone 16 to a digital processor 44 that is part of the stereo system 10. The processor receives the digital files and stores them on an associated memory card 46, and also decodes the files to convert them into analog form, where they are provided to the amplifier 36. This feature allows the system to download the files contained in the memory of the cell phone 16, or to use the cell phone to download directly to the processor 44. Then, the stereo system can continue to play the downloaded music after the cell phone 16 has been removed from the cradle 14.

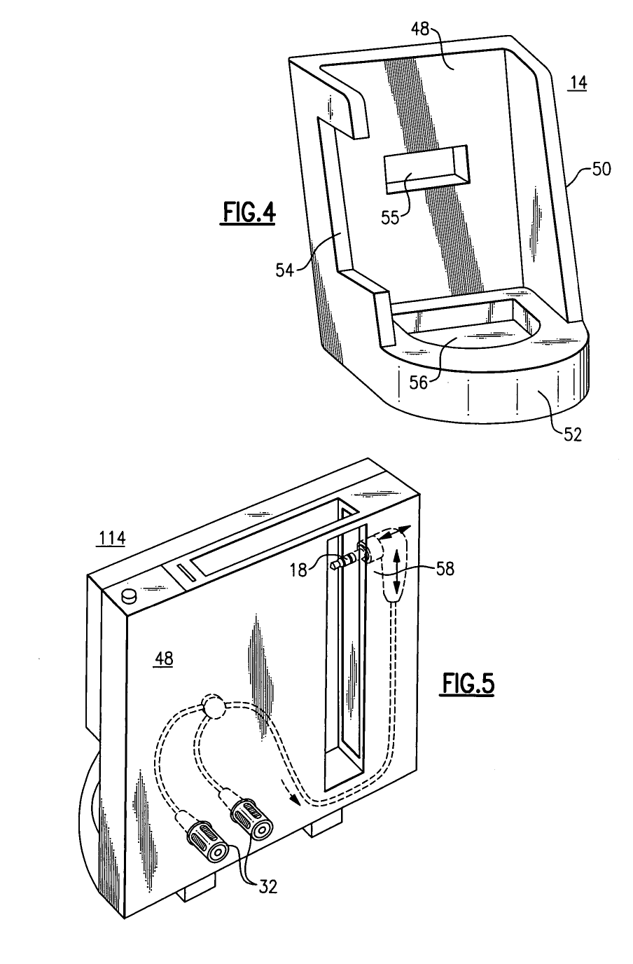

FIG. 4 shows one practical version of the cradle 14. He cradle has a back wall 48 right side wall 50, base 52, and left side wall with access slot 54. The slot 54 provides access to the stereo earphone socket, which is provided along the side of the phone 16 on the left side. This may be at slightly different heights on different makes and models, and the slot is sufficient to accommodate such variance in position. Also, there is an opening 56 at the base 52 where the recharger connector 22 can be positioned, although in some embodiments, that can be omitted. A recess 55 is also provided in the back wall 48, as some cell phone models may have the earphone socket or line-out jack on the back wall of the cell phone, and this recess 5 will accommodate the mini-plug 18.

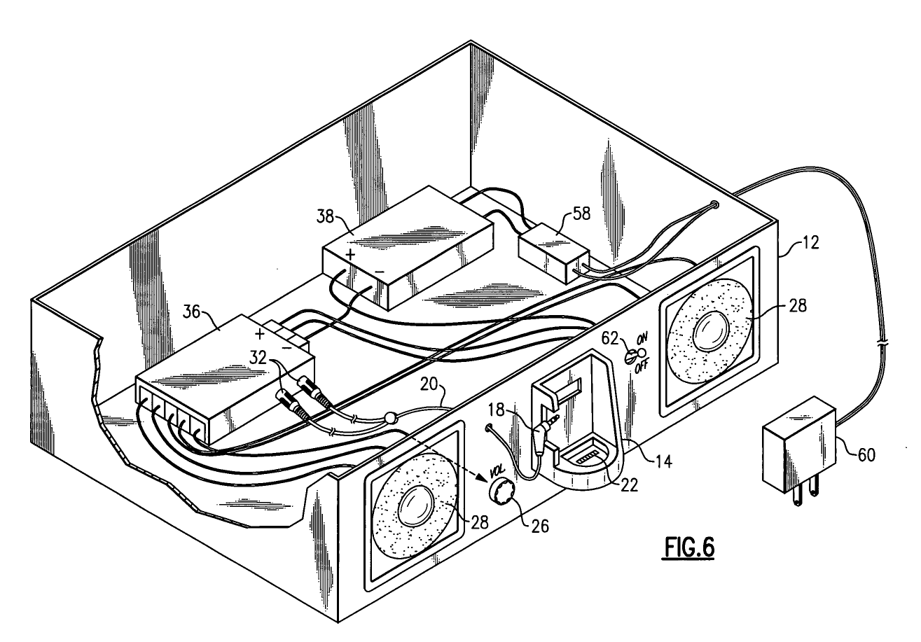

An alternative embodiment of the cradle 14′ is shown, in pertinent part, in FIG. 5. Here, the parts that are identical with the first embodiment are identified with the same reference characters, or are omitted or obscured from this view. Here, the cradle 14′ is shown from the rear. The cable 20 is built into the cradle 14′. At one side of the back wall 48 is a slider 58 that contains the head or mini plug 18. The slider allows movement in the up-down direction as well as in-out, to adjust for the location of the stereo headphone socket on the side of the phone 16. There can also be a stereo mini-plug in the back wall 48 to accommodate music-enabled phones that have the earphone socket in the back. In this embodiment, the L and R RCA connectors 32, 32 are mounted or secured on the back wall 48, and project out from it. This construction allows the cradle to be pushed directly onto the L and R channel input connectors of the associated stereo amplifier 36, making installation as simple as possible.

FIG. 6 shows one possible layout arrangement of components within the case 12 of the portable cell phone dock stereo system 10. The cradle 14 is positioned on the front of the case, and the cable 20 is shown with the stereo plug 18, and the connector 22. The cable 20 has its RCA connectors 32, 32 connected to the amplifier 36. An internal battery charger 58 is provided for the internal rechargeable battery 38, and can also supply charging current to the recharger connector 22 for the cell phone. A twelve-volt transformer 60 provides suitable power to the recharger 58 via an external cord. Alternatively, a cigarette-lighter plug or other low voltage connector can be used here, e.g., to connect to a 12 volt automotive electrical system. Finally, an on-off switch 62 is shown on the front panel.

The cradle 14 can be built in to an automotive, in-dash audio system for a car or truck, and permit the motorist's music-enabled cell phone 16 to be used as a music source. The motorist can easily scroll to the desired song or tune, and play it over the automotive sound system. At the same time, the automotive audio system provides hands-free operation for the motorist making or receiving a phone call.

Many other modifications and variations are possible which would not depart from the scope and spirit of this invention, as defined in the appended claims.

I claim:

1. Portable docking station for a cell phone instrument of the type capable of downloading and storing music files and playing said files back as stereo audio signals via a stereo headphone jack on the cell phone instrument, comprising:
a cradle for holding said cell phone instrument;
a cables having a stereo plug at one end adapted to fit the stereo jack on the cell phone, and a pair of audio connectors at another end of the cable adapted for connecting to L and R audio inputs of a stereo amplifier.

2. Portable docking station according to claim 1 wherein said cell phone instrument includes a memory chip for storing a multiplicity of said music files, and means for displaying and selecting said music files for playback.

3. Portable docking station according to claim 1 wherein said cable is contained within said cradle.

4. Portable docking station according to claim 3 wherein said audio connectors are mounted on a rear panel of said cradle.

5. Portable docking station according to claim 3 wherein said stereo plug is mounted on a slider mechanism contained in said cradle.

6. Portable docking station according to claim 5 wherein said slider mechanism provides freedom of motion of the stereo plug over a limited distance, so that the plug can be moved to adjust the cradle for any of a variety of cell phone instruments.

7. Portable docking station according to claim 1 further comprising an audio entertainment system that includes a case, a stereo amplifier within the case, a volume control for controlling gain of the amplifier, and a pair of speakers supplied by said stereo amplifier; and wherein said cradle is affixed onto said case, with the audio connectors of said cable being connected to respective inputs of said stereo amplifier; such that the cell phone instrument serves as an audio input source for said audio entertainment system.

8. Portable docking station according to claim 7 wherein said cradle further comprises a connector fitting into a digital coupling at a base of said cell phone instrument, and connected to a digital processor within said case for accessing said music files as digital files from said cell phone instrument, converting same into audio files, and supplying same to said audio amplifier as L and R audio signals.

9. Portable docking station according to claim 1 wherein said cradle includes means for recharging said cell phone instrument.
